(19) United States
(12) Patent Application Publication
(10) Pub. No.: US 2018/0122396 A1
(43) Pub. Date: May 3, 2018

(54) METHOD AND APPARATUS FOR PROCESSING AUDIO SIGNALS ON BASIS OF SPEAKER INFORMATION

(71) Applicant: SAMSUNG ELECTRONICS CO., LTD., Suwon-si (KR)

(72) Inventors: Yoon-jae LEE, Seoul (KR); Chang-yeong KIM, Seoul (KR); Eun-mi OH, Seoul (KR); Sun-min KIM, Yongin-si (KR); Hae-kwang PARK, Suwon-si (KR); Ji-ho CHANG, Suwon-si (KR); Jae-youn CHO, Suwon-si (KR); Seon-ho HWANG, Yongin-si (KR)

(73) Assignee: SAMSUNG ELECTRONICS CO., LTD., Suwon-si (KR)

(21) Appl. No.: 15/566,278

(22) PCT Filed: Feb. 23, 2016
(86) PCT No.: PCT/KR2016/001725

§ 371 Date: Oct. 13, 2017

(30) Foreign Application Priority Data
Apr. 13, 2015 (KR) 10-2015-0052080

(51) Int. Cl. G10L 19/26; H04R 5/04; H04R 5/02

(52) U.S. Cl. CPC G10L 19/26; H04R 2205/024; H04R 5/02; H04R 5/04

(57) ABSTRACT

A method of processing an audio signal includes obtaining filter functions for audio signals, the filter functions determined according to predetermined locations of a plurality of speakers; obtaining location information of the plurality of speakers via which the audio signals are to be output; correcting the filter functions based on the location information; and processing the audio signals by using the corrected filter functions.

### TECHNICAL FIELD

One or more exemplary embodiments relate to a method and apparatus for processing an audio signal based on information regarding a speaker via which the audio signal is output.

### BACKGROUND ART

Audio systems capable of outputting an audio signal via a multi-channel (e.g., the 5.1 channel, the 2.1 channel, etc.) have been introduced. An audio signal may be processed and output, based on the locations of speakers via which the audio signal is to be output.

However, the locations of the speakers may be different from a reference location for processing an audio signal or may not be fixed according to an ambient environment in which the speakers are installed or mobility of the speakers. Thus, when the locations of the speakers are changed, an audio providing system may process the audio signal based on locations different from the current locations of the speakers and cannot thus provide a high-quality audio signal to a listener.

### DETAILED DESCRIPTION OF THE INVENTION

### Technical Solution

One or more exemplary embodiments include a method and apparatus for processing an audio signal based on location information of speakers via which the audio signal is to be output, thereby adaptively processing the audio signal according to information regarding the speakers.

### Advantageous Effects

In one exemplary embodiment, an audio signal may be processed based on location information of a plurality of speakers present at arbitrary locations, thereby providing a listener with an audio signal having high sound quality.

### DESCRIPTION OF THE DRAWINGS

FIG. 1 illustrates a stereo channel audio system according to an exemplary embodiment.

FIG. 2 is a diagram illustrating a method of obtaining current location information of a speaker according to an exemplary embodiment.

FIG. 3 is a block diagram of an internal structure of an apparatus for correcting a filter function based on location information of a speaker according to an exemplary embodiment.

FIG. 4 is a flowchart of a method of processing an audio signal according to an exemplary embodiment.

FIG. 5 is a graph showing a filter function having flat frequency response characteristics according to an exemplary embodiment.

FIG. 6 is a graph showing filter functions configured to prevent signal loss due to a phase difference according to an exemplary embodiment.

FIG. 7 is a diagram illustrating a case in which a notch filter is applied to an audio signal according to an exemplary embodiment.

FIG. 8 is a diagram illustrating a case in which a decorrelator filter is applied to an audio signal according to an exemplary embodiment.

FIG. 9 is a diagram illustrating a method of processing stereo signals according to an exemplary embodiment.

FIG. 10 is a block diagram of an internal structure of an audio signal processing apparatus according to an exemplary embodiment.

### BEST MODE

According to one or more exemplary embodiments, a method of processing an audio signal includes obtaining filter functions determined for an audio signal according to predetermined locations of a plurality of speakers; obtaining location information of the plurality of speakers via which the audio signal is to be output; correcting the filter functions based on the location information; and processing the audio signal by using the corrected filter functions.

The method may further include outputting the processed audio signal such that a sound image of the audio signal is located at a predetermined location on a multimedia device.

The method may further include sensing a change in the location information of at least one of the plurality of speakers; correcting the filter functions based on the sensed location information; and processing the audio signals by using the corrected filter functions.

The location information may include at least one of a distance and angle between each of the plurality of speakers and a listener.

The correcting of the filter functions may include determining parameters based on the location information; and correcting the filter functions by using the parameters.

The parameters may include at least one of a panning gain for correcting a direction of a sound image of the audio signal, based on the location information of the plurality of speakers; a gain for correcting a sound level of the sound image of the audio signal, based on the location information of the plurality of speakers; and a delay time for compensating for a difference between phases of sound images of the audio signal, based on the location information of the plurality of speakers.

The filter functions may include filter functions having flat frequency response characteristics in a predetermined frequency band and configured to add a feeling of elevation to the audio signal, or filter functions configured to add notch characteristics to the audio signal, wherein the notch characteristics are characteristics of an audio signal to which the feeling of elevation is added.

According to one or more exemplary embodiments, an apparatus for processing an audio signal includes a receiving unit for obtaining an audio signal and location information of a plurality of speakers via which the audio signal is to be output; a control unit for obtaining filter functions determined for the audio signal according to predetermined locations of the plurality of speakers, correcting the filter functions based on the location information, and processing the audio signal by using the corrected filter functions; and an output unit for outputting the processed audio signal via the plurality of speakers.

### MODE OF THE INVENTION

Hereinafter, exemplary embodiments of the inventive concept will be described in detail. In the following description, well-known functions or constructions are not described in detail if it is determined that they would obscure the inventive concept due to unnecessary detail. Throughout the drawings, like reference numerals refer to like elements.

The terms or expressions used in the present specification and the claims should not be construed as being limited to as generally understood or as defined in commonly used dictionaries, and should be understood according to the technical idea of the inventive concept, based on the principle that the inventor(s) of the application can appropriately define the terms or expressions to optimally explain the inventive concept. Thus, the embodiments set forth in the present specification and drawings are just exemplary embodiments of the inventive concept and do not completely represent the technical idea of the inventive concept. Accordingly, it would be obvious to those of ordinary skill in the art that the above exemplary embodiments are to cover all modifications, equivalents, and alternatives falling within the scope of the inventive concept at the filing date of the present application.

In the accompanying drawings, some elements are exaggerated, omitted, or schematically illustrated. The sizes of the elements illustrated in the drawings should not be understood as the actual sizes thereof. Thus, the inventive concept is not limited by the relative sizes of the elements or the distances between the elements illustrated in the drawings.

It will be understood that the terms ‘comprise’ and/or ‘comprising,’ when used in this specification, specify the presence of stated features, integers, steps, operations, elements, and/or components, but do not preclude the presence or addition of one or more other features, integers, steps, operations, elements, components, and/or groups thereof. It will be further understood that when an element or layer is referred to as being ‘connected to’ another element or layer, the element or layer can be directly connected to another element or layer or can be electrically connected to another element or layer having intervening elements or layers therebetween.

Also, the term ‘unit’ used herein should be understood as software or hardware, e.g., an FPGA or an ASIC, for performing specific functions, but is not limited thereto. A “unit” may be configured to be included in an addressable storage medium or to run one or more processors. Thus, the term “unit” should be understood, for example, to include elements (such as software elements, object-oriented software elements, class elements, and task elements), processes, functions, attributes, procedures, subroutines, segments of program code, drivers, firmware, microcode, circuits, data, database, data structures, tables, arrays, and variables. Functions performed in elements or “units” may be combined to reduce a number of elements or “units” or may be divided into sub-functions to add additional elements or “units”.

In the present disclosure, the term ‘audio object’ means each of sound elements included in an audio signal. One audio signal may include various audio objects. For example, an audio signal containing a live recording of an orchestra concert includes a plurality of audio objects generated by a plurality of musical instruments such as a guitar, a violin, an oboe, etc.

In the present disclosure, the term ‘sound image’ means a point a user feels at which a sound source is generated. Actually, sound is output via speakers but points at which sound sources are virtually formed are referred to as sound images. The size and location of a sound image may vary according to a speaker via which sound is output. When the locations of sounds from sound sources are clear and the sounds from the sound sources are separately and distinctively heard to a listener, sound image fixing may be determined to be good. A sound image a listener feels at which a sound source of an audio object is generated may be present for each of audio objects.

As used herein, the term ‘and/or’ includes any and all combinations of one or more of the associated listed items. Expressions such as ‘at least one of,’ when preceding a list of elements, modify the entire list of elements and do not modify the individual elements of the list.

Exemplary embodiments will be described in detail so that those of ordinary skill in the art can easily accomplish them with reference to the accompanying drawings. However, the inventive concept may be embodied in many different forms and is not limited to embodiments set forth herein. A description of parts that are not related to clearly describing the inventive concept is omitted here.

Hereinafter, exemplary embodiments will be described with reference to the accompanying drawings.

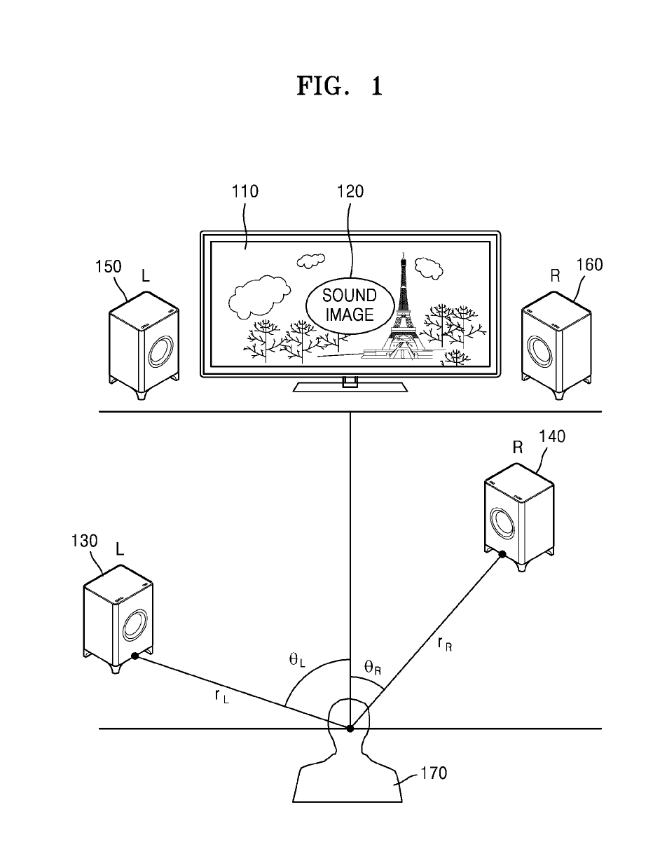

FIG. 1 illustrates a stereo channel audio system according to an exemplary embodiment.

Referring to FIG. 1, speakers that output an audio signal via a stereo channel may be present at arbitrary locations. The speakers may output an audio signal processed by an audio signal processing apparatus (not shown). When the speakers are high-mobility devices such as wireless speakers, the locations of the speakers may be changed in real time. According to an exemplary embodiment, the audio signal processing apparatus may sense a change in location information of the speakers and process an audio signal based on the changed location information. The audio signal processing apparatus may process an audio signal by using a filter function adaptively determined according to a change in the locations of the speakers.

The audio signal processing apparatus may obtain a sound image 120 of the audio signal, and filter functions determined based on predetermined locations 150 and 160 of the speakers. The predetermined locations 150 and 160 are values for obtaining the filter functions and may be thus different from actual current locations of the speakers. The audio signal processing apparatus may enhance the sound quality of the audio signal by using the filter functions. The audio signal processed using the filter functions may be output in an optimum state via the speakers at predetermined locations 150 and 160. Filter functions corresponding to channels of the audio signal may be provided. For example, when the audio signal is output via left and right speakers, filter functions may be present for respective audio signals output via the left and right speakers. The audio signal may be processed using filter functions in units of audio objects thereof. The filter functions may be corrected based on current location information 130 and 140 of the respective speakers.

For example, the predetermined locations 150 and 160 of the speakers may be determined to be symmetrical to each other with respect to the location of a listener 170. The predetermined locations 150 and 160 of the speakers may be determined such that the speakers are located to be symmetrical to each other in front of the listener 170. Thus, the distances between the speakers and the listener 170 may be the same. The current location information 130 and 140 of the respective speakers may be location information that may be determined based on the location of the listener 170. The current location information 130 and 140 of the speakers may be relative location information based on the location of the listener 170. Thus, the location of the listener 170 may be arbitrarily determined. However, the inventive concept is not limited to the above exemplary embodiment and the current location information 130 and 140 of the respective speakers may be determined differently.

The filter functions determined based on the predetermined locations 150 and 160 are values determined beforehand by the manufacturer of the audio signal processing apparatus or a user, based on a value stored in a memory of an apparatus. Otherwise, the filter functions determined based on the predetermined locations 150 and 160 may be values received from the outside or calculated by the audio signal processing apparatus. However, exemplary embodiments are not limited thereto and the filter functions determined based on the predetermined locations 150 and 160 may be values obtained in various ways.

The sound image 120 of the audio signal may be located at different locations in units of audio objects. For example, the sound image 210 may be located on a display device 110 that displays a video signal corresponding to the audio signal. Sound images 120 corresponding to audio objects may be provided, and filter functions may be applied to improve the sound quality of the audio signal with respect to the respective sound images 120. Different filter functions may be applied to the audio signal in units of channels. Since the filter functions may be corrected based on location information of the speakers, the filter functions may be corrected without considering a location at the sound image 120 is located.

The audio signal processing apparatus may obtain the current location information 130 and 140 of the speakers to determine parameters for correcting the filter functions. The current location information 130 and 140 of the speakers may be obtained in real time or when a change in the location of at least one of the speakers is sensed by the audio signal processing apparatus. The audio signal processing apparatus may correct the filter functions, process the audio signal by using the corrected filter functions, and output a result of processing the audio signal whenever the locations of the speakers are changed.

The current location information 130 and 140 of the speakers may include coordinates, the origin of which is the location of the listener 170 or information regarding a distance and angle between each of the speakers and the listener 170. For example, the current location information 130 and 140 of the speakers may include information regarding distances and angles between the listener 170 and the speakers. When the current location information 130 and 140 of the speakers are coordinates, the coordinates may be converted into distance information and angle information determined with respect to the location of the listener 170 as described above. For example, when the coordinates of a speaker are (x, y), location information of the speaker may be converted into an angle θ=π/2−tan⁻¹(y/x) and a distance r=y/cosθ.

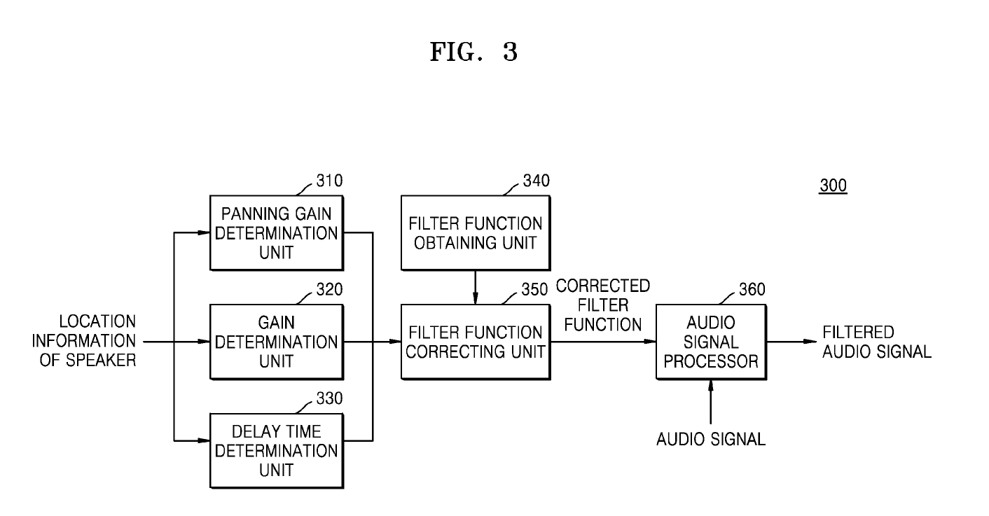

The audio signal processing apparatus may calculate parameters for correcting the filter functions based on the current location information 130 and 140 of the speakers, and correct the filter functions by using the parameters. The parameters for correcting the filter functions will be described in more detail with reference to FIG. 3 below.

According to an exemplary embodiment, the audio signal processing apparatus may be included in the display device 110 that processes a video signal corresponding to the audio signal or may be the display device 110. However, exemplary embodiments are not limited thereto, and the audio signal processing apparatus may be various apparatuses connected in a wire or wireless manner to speakers via which an audio signal is output.

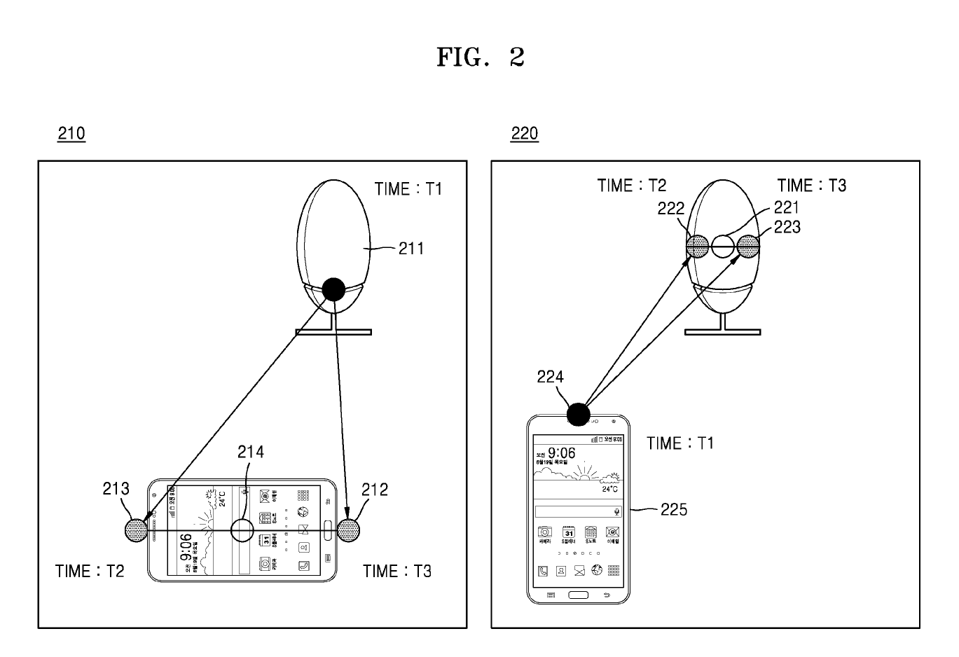

A method of obtaining location information of a speaker will be described in more detail with reference to FIG. 2 below.

FIG. 2 is a diagram illustrating a method of obtaining current location information of a speaker according to an exemplary embodiment. In the method of FIG. 2, the location of a listener may be determined based on the location of the listener's mobile device, e.g., a smart phone. However, exemplary embodiments are not limited thereto, and the location of the listener may be determined based on various terminals, e.g., a wearable device, a personal digital assistant (PDA), etc.

Referring to a diagram 210 of FIG. 2, location information of a speaker 211 may be obtained based on a central location 214 on a mobile device of a listener. When sound is output via the speaker 211, the output sound may be input to microphones 212 and 213 of the mobile device via different paths. Thus, the lengths of the paths may be determined based on a moving time T2−T1 of the sound input to the microphone 212 and a moving time T3−T1 of the sound input to the microphone 213. If the speed of sound is assumed to be 340 m/s, each of the lengths of the paths may be determined to be 340×(moving time). Information regarding the distance and angle between the central location 214 corresponding to the location of the listener and the speaker 211 may be determined based on the lengths of the paths and the distance between the microphones 212 and 213.

Referring to a diagram 220 of FIG. 2, location information of the speaker 221 may be obtained based on a location of a speaker 224 of a listener's mobile device 225. In order to obtain the location information of the speaker 221, the mobile device 225 may include the speaker 224 and the speaker 221 may include microphones 222 and 223. When sound is output via the speaker 224 of the mobile device 225, the output sound may be input to the microphones 222 and 223 of the speaker 221 via different paths. Thus, each of the lengths of the paths may be determined to be 340×(moving time), based on a moving time T2−T1 of the sound input to the microphone 222 from the speaker 224 and a moving time T3−T1 of the sound input to the microphone 223 from the speaker 224. Also, information regarding the distance and angle between the speaker 224 corresponding to the location of the listener and the speaker 221 may be obtained based on the lengths of the paths and the distance between the microphones 222 and 223.

The method of obtaining location information of a speaker illustrated in FIG. 2 is, however, an example and location information of a speaker may be obtained according to various methods.

A method of determining parameters for correcting a filter function based on location information of a speaker and correcting the filter function by using the parameters will be described in more detail with reference to FIG. 3 below.

FIG. 3 is a block diagram of an internal structure of an apparatus for correcting a filter function based on location information of a speaker according to an exemplary embodiment.

Referring to FIG. 3, an audio signal processing apparatus 300 according to an exemplary embodiment may include a panning gain determination unit 310, a gain determination unit 320, a delay time determination unit 330, a filter function obtaining unit 340, a filter function correcting unit 350, and an audio signal processor 360.

The panning gain determination unit 310, the gain determination unit 320, and the delay time determination unit 330 may determine different parameters based on location information of a speaker.

The panning gain determination unit 310 may determine a panning gain for correcting the directions of audio signals output via speakers. As the speakers are moved, the directions of sound output via the speakers are panned with respect to a listener. Thus, the panning gain may be determined based on a degree to which the direction of sound output via each of the speakers is panned. The panning gain determination unit 310 may determine a panning gain, based on angles (θ_{L}, θ_{R}) at which the speakers are panned at the predetermined location 150 with respect to the location of the listener 170. A panning gain may be determined for each of the speakers. For example, the panning gain may be determined by Equation 1 below.

$${G}_{p \_ L} = cos ( \frac{π \vert {θ}_{L} \vert}{2 ( \vert {θ}_{L} \vert + \vert {θ}_{R} \vert )} ) , \\ {G}_{p \_ R} = sin ( \frac{π \vert {θ}_{L} \vert}{2 ( \vert {θ}_{R} \vert + \vert {θ}_{R} \vert )} ) \qquad [ Equation 1 ]$$

The gain determination unit 320 may determine a gain for correcting the intensities of sound of audio signals output via the speakers. As a speaker is moved, the distance between the speaker and a listener changes. Thus, the intensity of sound output via the speaker may change according to the location of the listener. For example, when the distance between a speaker and the listener is shorter than those between another speaker and the listener, the intensity of sound output via the speaker is higher at the location of the listener than that of sound output via the other speaker. In contrast, when the intensity of sound output via the speaker is lower at the location of the listener than that of sound output via the other speaker, a sound image may be moved.

The gain determination unit 320 may determine a gain, based on the distances (r_{L}, r_{R}) between the listener 170 and the speakers. For example, a gain may be determined by Equation 2 below. A gain that may be determined by Equation 2 below is based on an assumption that the distances between the speakers and the listener 170 are the same at the predetermined location 150. However, the gain is not limited by Equation 2 below and may be determined according to various methods, based on the distances between the speakers and the listener 170 at the predetermined location 150.

$${G}_{d} = {10}^{{G}_{d B} / 20} , {G}_{d B} = 20 \cdot {log}_{10} ( \frac{{r}_{L}}{{r}_{R}} ) \qquad [ Equation 2 ]$$

The delay time determination unit 330 may determine a delay time for compensating for a phase difference between audio signals output via the speakers. When at least one of the speakers is moved, the distances between the speakers and the listener 170 become different and thus the phases of sound output via the speakers may be different at the location of the listener 170.

The delay time determination unit 330 may determine a delay time based on the distances (r_{L}, r_{R}) between the listener 170 and the speakers. For example, the delay time may be determined by the difference between times required for sound to arrive from the speakers to the location of the listener 170 as shown in Equations 3 and 4 below. In Equations 3 and 4, “340 m/s” denotes the speed of sound. The delay time may vary according to an ambient environment in which sound is delivered, e.g., according to the state of a medium through which the sound is delivered.

The delay time may be determined by Equation 3 below when the distance r_{L} is shorter than the distance r_{R}, and may be determined by Equation 4 below when the distance r_{L} is longer than the distance r_{R}. The delay time that may be determined by Equation 3 or 4 is based on an assumption that the distances between the speakers and the location of the listener 170 are the same at the predetermined locations 150 and 160. However, the delay time is not limited by Equations 3 and 4 and may be determined according to various methods, based on the distances between the speakers and the listener 170 at the predetermined location 150.

t_{d}=(r_{R}−r_{L})/340 (m/s) [Equation 3]

tₜ=(r_{L}−r_{R})/340 (m/s) [Equation 4]

The filter function obtaining unit 340 may obtain filter functions for improving the sound quality of audio signals output via the speakers, based on the predetermined locations 150 and 160 of the speakers. The predetermined locations 150 and 160 of the speakers may be determined to be symmetrical to each other in front of the listener 170.

The filter function correcting unit 350 may correct the filter functions obtained by the filter function obtaining unit 340, based on at least one of the determined parameters. For example, the filter functions may be corrected according to Equations 5 and 6 below. In Equations 5 and 6, “H_{L}” and “H_{R}” respectively denote filter functions that correspond to audio signals output via the speakers and are obtained by the filter function obtaining unit 340. “H′_{L}” and “H′_{R}” denote filter functions that correspond to the speakers and are corrected by the filter function correcting unit 350.

The filter functions may be corrected by Equation 5 when the distance r_{L} is shorter than the distance r_{R}, and may be corrected by Equation 6 when the distance r_{L} is longer than the distance r_{R}. When the distance between one of the speakers and the listener 170 is shorter than the distance between the other speaker and the listener 170, the phase of the speaker leads that of the other speaker, and the difference between the phases of the speakers may be compensated for by using the delay time. However, the filter functions are not limited by Equations 5 and 6 and may be corrected according to various methods.

H′_{L}(t, r_{L}, r_{R}, θ_{L}, θ_{R})=G_{d}*G_{P}_{_}_{L}*H_{L}(t−t_{d})

H′_{R}(t, r_{L}, r_{R}, θ_{L}, θ_{R})=Gₚ_{_}_{R}*H_{R}(t) [Equation 5]

H′_{L}(t, r_{L}, r_{R}, θ_{L}, θ_{R})=Gₚ_{_{L}}*H_{L}(t)

H′_{R}(t, r_{L}, r_{R}, θ_{L}, θ_{R})=G_{d}*Gₚ_{_}_{R}*H_{R}(t−t_{d}) [Equation 6]

The audio signal processor 360 may process an audio signal by using the corrected filter functions, and output a result of processing the audio signal. For example, as shown in Equation 7 below, the audio signal processor 360 may process the audio signal by performing convolution on the audio signal and the corrected filter functions. In Equation 7, “L(t)” and “R(t)” denote audio signals that have yet to be processed, “H′_{L}(t)” and “H′_{R}(t)” denote the corrected filter functions, and “L′(t)” and “R′(t)” denote results of processing the audio signals by using the corrected filter functions.

L′(t)=L(t)*H′_{L}(t)

R′(t)=R(t)*H′_{R}(t) [Equation 7]

According to an exemplary embodiment, the audio signal processing apparatus may sense a change in the locations of the speakers in real time and process the audio signals by using filter functions corrected based on the changed locations of the speakers. When the filter functions may be expressed in the form of a set of impulse response functions, the amount of calculation may be lower when the filter functions are corrected based on the changed locations of the speakers than when the filter functions are corrected according to other methods.

The audio signals filtered using the corrected filter functions may be output via a plurality of speakers. Although a case in which audio signals output via two speakers are processed has been described in the above embodiment, exemplary embodiments are not limited thereto. According to an exemplary embodiment, when audio signals are output via more than two speakers, the audio signals may be processed by selecting two speakers via which the audio signals are to be output from among the speakers in units of audio objects.

For example, when a plurality of speakers are present on a horizontal plane, audio signals may be processed according to the above embodiment such that the audio signals are output via two speakers most adjacent in left and right directions to a location at which a sound image of each of audio objects is located.

When the heights of speakers are different, audio signals may be processed based on location information of the speakers as described above. When the heights of speakers are different, the distances between a listener and the speakers are different. Thus, an audio signal processing apparatus may determine a delay time and a gain as described above based on information regarding the distances between the listener and the speakers, and correct filter functions based on the delay time and the gain. Also, when a head-related transfer function (HRTF) filter is used to process audio signals, HRTF filters corresponding to the heights of the speakers may be used.

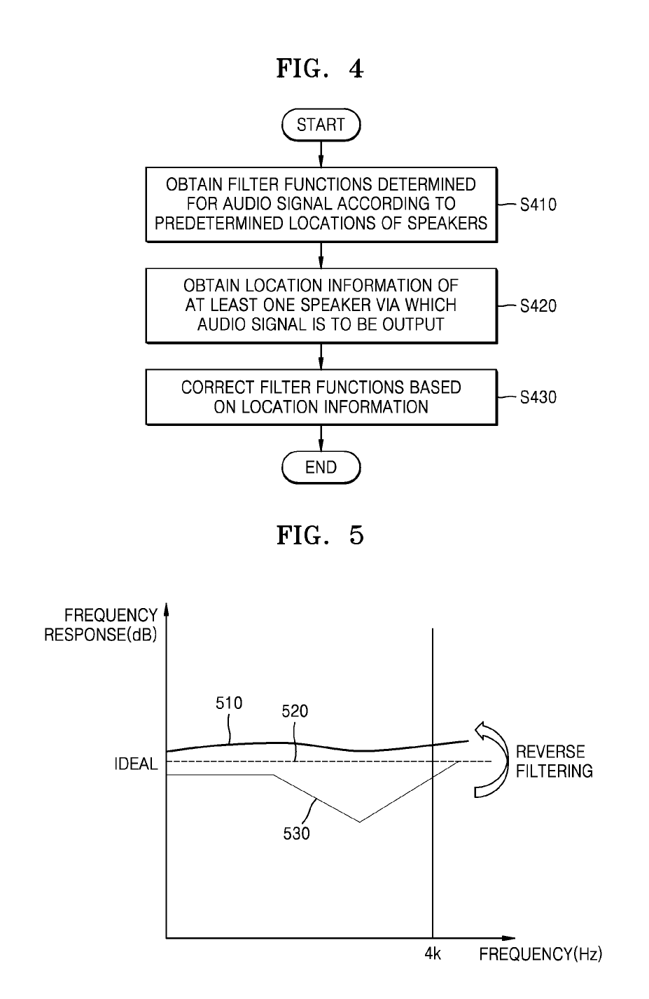

A method of processing an audio signal based on location information of speakers according to an exemplary embodiment will be described in more detail with reference to FIG. 4 below.

FIG. 4 is a flowchart of a method of processing an audio signal according to an exemplary embodiment.

Referring to FIGS. 1 and 4, in operation S410, an audio signal processing apparatus may obtain filter functions determined for audio signals according to predetermined locations of speakers. For example, the predetermined locations 150 and 160 of the speakers may be symmetrical to each other with respect to the location of the listener 170. The filter functions determined according to the predetermined locations 150 and 160 may be values determined beforehand by the manufacturer of the audio signal processing apparatus, and stored in a memory of the audio signal processing apparatus or received from the outside.

In operation S420, the audio signal processing apparatus may obtain location information of a plurality of speakers via which an audio signal is to be output. For example, the audio signal processing apparatus may obtain location information of the plurality of speakers which are present at predetermined locations and different locations and via which an audio signal is to be output.

When a change in the location of at least one of the plurality of speakers is sensed, the audio signal processing apparatus may obtain location information of the at least one speaker. The audio signal processing apparatus may periodically obtain location information of at least one of the plurality of speakers, and compare the obtained location information with the location information of the at least one speaker at a previous point of time to determine whether the location of the at least one speaker is changed.

In operation S430, the audio signal processing apparatus may correct the filter functions obtained in operation S410, based on the location information of the plurality of speakers obtained in operation S420. The audio signal processing apparatus may determine at least one parameter for correcting the filter functions based on the location information of the plurality of speakers, and correct the filter functions by using the at least one parameter. Also, the audio signal processing apparatus may process the audio signals by using the corrected filter functions and output the processed audio signals via the plurality of speakers.

An example of a filter for processing an audio signal will be described in more detail with reference to FIGS. 5 to 9 below.

A method of obtaining a filter for increasing the height of an audio signal by the filter function obtaining unit 340 according to an exemplary embodiment will be described with reference to FIGS. 5 to 8 below. According to an exemplary embodiment, a filter is a component configured to perform filtering so as to improve the sound quality of or an output state of an audio signal, and a filter function means a function to be applied to the audio by the filter.

FIG. 5 is a graph showing a filter function having flat frequency response characteristics according to an exemplary embodiment.

A filter function for increasing the feeling of elevation of an audio signal may exhibit notch characteristics. When a filter function having the notch characteristics is applied to an audio signal, the feeling of elevation of the audio signal may be perceived. However, when a filter for increasing the feeling of elevation of an audio signal, e.g., an HRTF filter, is used, the sound quality of the audio signal may be distorted instead of increasing the feeling of elevation of the audio signal. For example, when an HRTF filter having a filter function 530 of FIG. 5 is applied to an audio signal, the sound quality of the audio signal may be distorted.

Thus, the audio signal processing apparatus may process an audio signal by using a filter function corrected such that a filter applicable to an audio signal of a specific frequency band has frequency response characteristics, thereby enhancing the sound quality of the audio signal. The frequency response characteristics mean characteristics of output signals of an input signal in units of frequency bands. When the filter function 530 is used, the decibel (dB) of an output signal decreases with respect to an input signal of a middle-low frequency band (e.g., 0 to 4 kHz). When an audio signal is processed using the filter function 530, an audio signal having distorted sound quality may be output. When a filter function 510 or 520 is used, an output signal exhibits flat characteristics with respect to an input signal of a middle-low frequency band. The audio signal processing apparatus may process an audio signal by using a filter function corrected to have flat frequency response characteristics, e.g., the filter function 510 or 520.

Since the sound quality of a voice signal should be guaranteed to be perceptible to a listener, the specific frequency band may be determined to be a middle-low frequency band (e.g., 0 to 4 or 5 kHz) that may include a frequency of a voice signal. However, exemplary embodiments are not limited thereto, and a filter function that has flat frequency response characteristics and is applicable to audio signals of various frequencies may be applied to an audio signal.

In order to locate a sound image of a voice signal at a specific altitude, the audio signal processing apparatus may apply a filter function of increasing the feeling of elevation, such as an HRTF filter function, to an audio signal, and process the audio signal by using, for example, the filter function 510 of FIG. 5 having flat frequency response characteristics at a critical frequency band. Since the feeling of elevation of the voice signal decreases according to a degree to which the filter function is corrected to have flat frequency response characteristics, the audio signal processing apparatus may improve the sound quality of the voice signal while locating a sound image of the voice signal at a specific altitude.

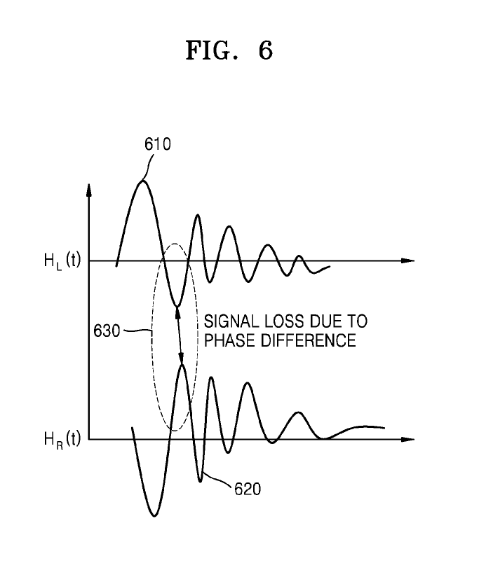

FIG. 6 is a graph showing filter functions 610 and 620 configured to prevent a signal loss due to a phase difference according to an exemplary embodiment.

Referring to FIG. 6, the filter functions 610 and 620 may be used to add a feeling of elevation to audio signals. However, the filter functions 610 and 620 are not limited thereto, and may include various functions of enhancing the sound quality or output state of audio signals. When audio signals are output via a plurality of speakers, an audio signal processing apparatus may process the audio signals by using filter functions of preventing a loss in the audio signals due to destructive interface caused by a phase difference between the audio signals. The audio signal processing apparatus may correct filter functions to be applied to the audio signals output from the plurality of speakers so as to prevent a loss in audio signals of a predetermined frequency band, e.g., a low frequency band, due to a phase difference between the audio signals. Since destructive interference caused by a phase difference between signals is less likely to occur in signals of a high frequency than in signals of a low frequency, a filer function to be applied to audio signals of a low frequency may be corrected.

In FIG. 6, referring to a reference numeral ‘630’, a loss may occur in audio signals due to a phase difference between the filter functions 610 and 620 to be applied to the audio signals output via the plurality of speakers. When the audio signals output via the plurality of speakers are substantially the same, a loss may occur in the audio signals due to a phase difference between filter functions to be applied to the audio signals. The audio signal processing apparatus may detect sections of the audio signals in which a signal loss occurs by periodically checking whether a loss occurs in the audio signals due to destructive interference.

The audio signal processing apparatus may prevent a loss in the audio signals due to the phase difference between the filter functions by changing the sign of one of the filter functions or reducing an absolute size of one of the filter functions within specific sections of the audio signals.

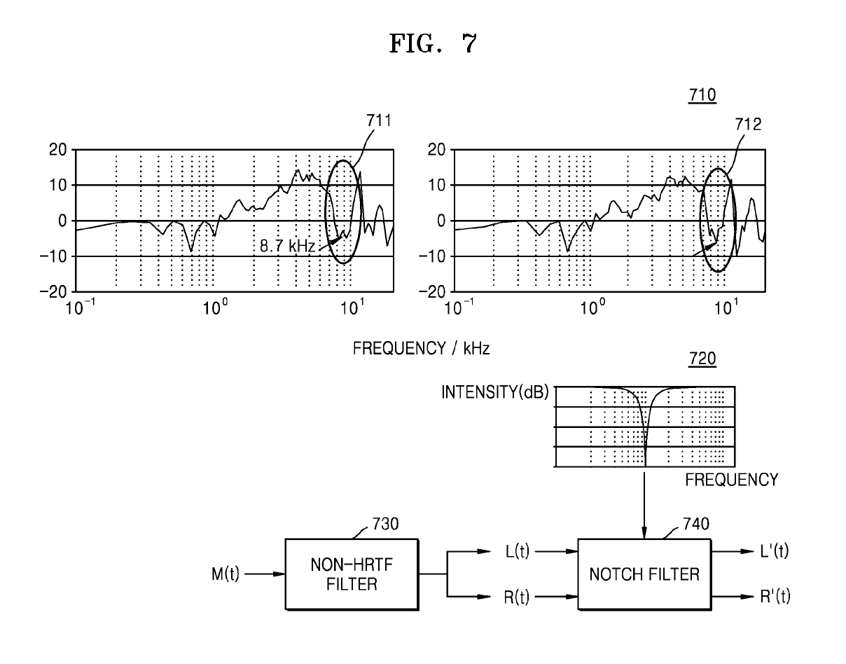

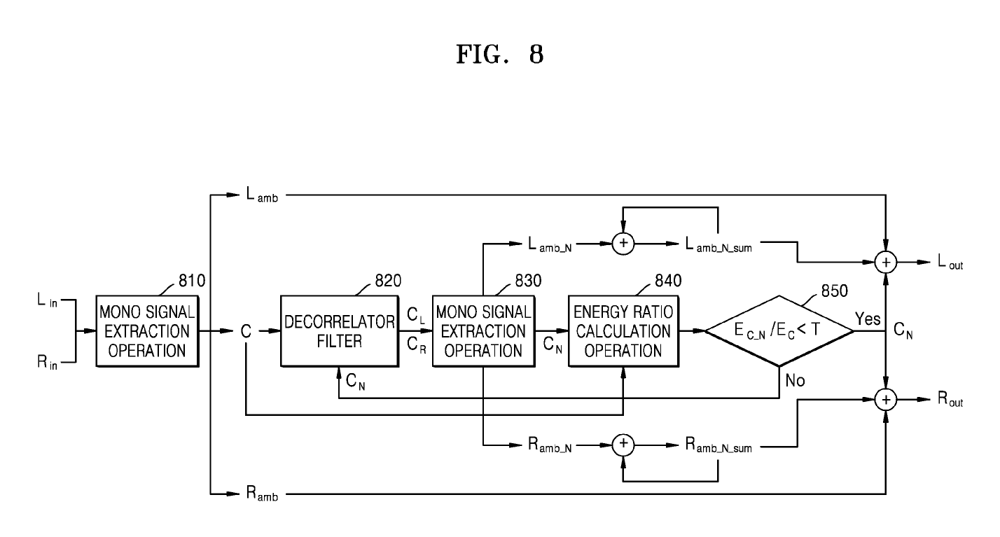

A method of improving the sound quality of an audio signal when a non-HRTF filter, for example, a decorrelator filter, is used as a filter for adding a feeling of elevation to the audio signal will be described with reference to FIGS. 7 and 8 below.

When the decorrelator filter is applied to an audio signal, the audio signal which is a mono signal may be converted into stereo signals, and the stereo signals are panned and output in a horizontal/vertical direction. Thus, a feeling of elevation may be added to the audio signal. The decorrelator filter may be used as a filter for adding the feeling of elevation to the audio signal, instead of the HRTF filter.

FIG. 7 is a diagram illustrating a case in which a notch filter is applied to an audio signal according to an exemplary embodiment.

Referring to FIG. 7, when a non-HRTF filter 730, e.g., a decorrelator filter, is applied to add a feeling of elevation to an audio signal M(t) which is a mono signal, the audio signal M(t) may be converted into stereo signals L(t) and R(t).

In addition, an audio signal processing apparatus may apply a notch filter 740 having notch characteristics which are the characteristics of an HRTF filter to the stereo signals L(t) and R(t) so as to additionally add the feeling of elevation to the stereo signals L(t) and R(t).

Since notch characteristics of a filter function of creating the feeling of elevation may occur mainly in a high frequency band of 5 kHz or more, the notch filter 740 may be applied to an audio signal of a high frequency (e.g., 5 kHz or more).

As shown in a graph 710, the notch filter 740 may determine filter functions to be applied to the stereo signals L(t) and R(t), based on notch characteristics occurring in an HRTF filter function corresponding to a specific horizontal angle and angle of altitude. The specific horizontal angle means an angle that may be measured on a horizontal plane, e.g., a direction angle, an azimuth, etc. The specific angle of altitude may be determined to be an angle of altitude to be applied to the audio signal M(t). Referring to the graph 710, at an angle of altitude of 30 degrees, notch characteristics 711 and 712 of the HRTF filter occur at frequencies of 8.7 and 8.8 kHz. Thus, the notch filter 740 may determine filter functions to be applied to the stereo signals L(t) and R(t) such that a filter function to be applied to the stereo signal L(t) has notch characteristics at 8.7 kHz and a filter function to be applied to the stereo signal R(t) has notch characteristics at 8.8 kHz. The audio signal processed by the notch filter 740 may be output as the audio signal having an angle of altitude of 30 degrees.

FIG. 8 is a diagram illustrating a case in which a decorrelator filter 820 is applied to an audio signal according to an exemplary embodiment.

Referring to FIG. 8, the decorrelator filter 820 may be repeatedly applied to an audio signal. As the decorrelator filter is repeatedly applied to an audio signal, a decorrelation between stereo signals converted from the audio signal may increase. For example, when the decorrelation between the stereo signals increases, the stereo signals may contain almost different audio signals. The decorrelator filter 820 may determine the decorrelation between the stereo signals, based on an environment in which the audio signal is output, characteristic information of the audio signal, or preset information. The decorrelator filter 820 may be repeatedly applied to the audio signal according to the decorrelation between the stereo signals.

Since the decorrelator filter 820 is applicable to mono signals, stereo signals Lᵢₙ and Rᵢₙ may be divided into a mono signal C and non-mono signals L_{amb} and R_{amb} in a mono signal extraction operation 810. Then, the decorrelator filter 820 may be applied to the mono signal C to generate stereo signals C_{L} and C_{R} from the mono signal C. Next, a mono signal C_{N} may be extracted from the stereo signal C_{L} and C_{R} in a mono signal extraction operation 830.

Whether the decorrelator filter 820 is to be repeatedly applied may be determined according to a ratio E_{C}_{_}_{N}/E_{C} between the energies of the mono signals C and C_{N} calculated in an energy ratio calculation operation 840. In an arithmetic operation 850, when the ratio E_{C}_{_}_{N}/E_{C} between the energies of the mono signals C and C_{N} is less than a reference value T, the decorrelator filter 820 may be applied once more to the mono signal C_{N}.

When the ratio E_{C}_{_}_{N}/E_{C} between the energies of the mono signals C and C_{N} is equal to or greater than the reference value T, the decorrelator filter 820 may not be applied any longer and final stereo signals Lₒᵤₜ and Rₒᵤₜ may be output. The final stereo signals Lₒᵤₜ and Rₒᵤₜ may be a result of combining the sum of the results of dividing the stereo signals in the mono signal extraction operations 810 and 830 and a result of adding the mono signal C_{N} to the stereo signals.

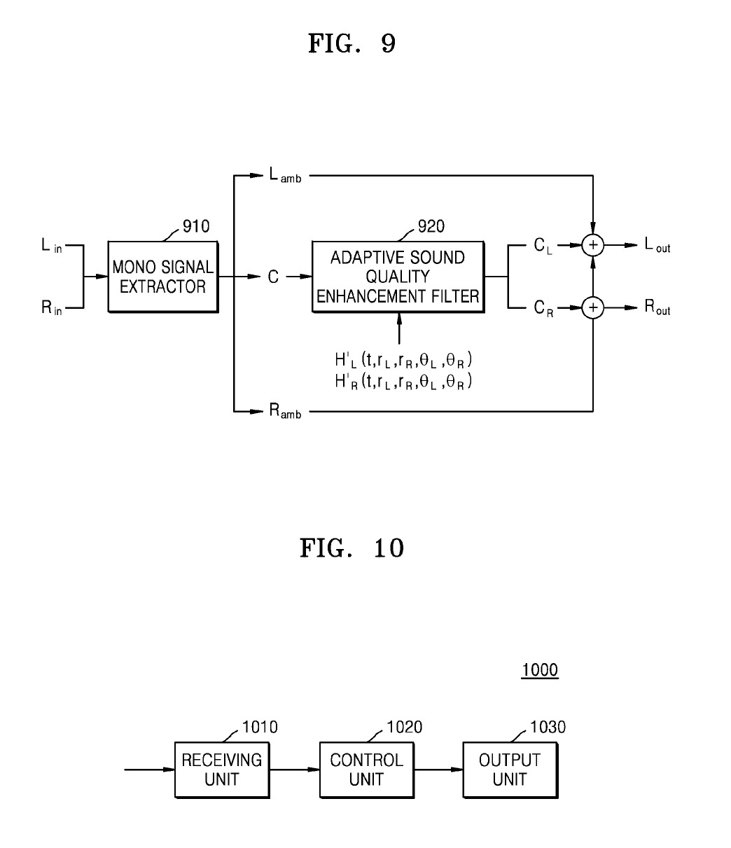

FIG. 9 is a diagram illustrating a method of processing stereo signals according to an exemplary embodiment. In FIG. 9, a mono signal extractor 910 and an adaptive sound quality enhancement filter 920 may be included in the audio signal processor 360 of FIG. 3.

Referring to FIG. 9, when a filter function applicable to a mono signal is present among filter functions to be used to process an audio signal, a mono signal C may be extracted from stereo signals Lᵢₙ and Rᵢₙ by the mono signal extractor 910. Then, the filter function may be applied to the mono signal C by the adaptive sound quality enhancement filter 920.

The adaptive sound quality enhancement filter 920 may include, for example, the decorrelator filter 820 described above. The adaptive sound quality enhancement filter 920 may apply corrected filter functions H′_{L} and H′_{R} to stereo signals separated from the mono signal C by the decorrelator filter 820. Stereo signals C_{L} and C_{R} output from the adaptive sound quality enhancement filter 920 may be combined with the mono signal C extracted by the mono signal extractor 910 and residual signals L_{amb} and R_{amb}, and a result of combining these signals may be output.

An audio signal processing apparatus will be described in detail with reference to FIG. 10 below.

FIG. 10 is a block diagram of an internal structure of an audio signal processing apparatus 1000 according to an exemplary embodiment.

According to an exemplary embodiment, the audio signal processing apparatus 1000 may be a terminal device that may be used by a user. Examples of the audio signal processing apparatus 1000 may include a smart television (TV), an ultra high definition (UHD) TV, a monitor, a personal computer (PC), a notebook computer, a mobile phone, a tablet PC, a navigation terminal, a smart phone, a personal digital assistant (PDA), a portable multimedia player (PMP), and a digital broadcast receiver.

Referring to FIG. 10, the audio signal processing apparatus 1000 may include a receiving unit 1010, a control unit 1020 and an output unit 1030.

The receiving unit 1010 may obtain an audio signal and location information of a plurality of speakers via which the audio signal is to be output. The receiving unit 1010 may periodically obtain location information of the plurality of speakers. For example, the location information may be obtained by either a sensor which is included in each of the plurality of speakers to sense a location of the speaker or an external device which senses the location of the speaker. However, embodiments are not limited thereto and the receiving unit 1010 may obtain the location information of the plurality of speakers according to various methods.

The control unit 1020 may obtain filter functions determined for audio signals according to predetermined locations, and correct the filter functions based on the location information of the plurality of speakers obtained by the receiving unit 1010. The control unit 1020 may correct the filter functions whenever the location information of at least one of the plurality of speakers changes.

The output unit 1030 may output the audio signals processed by the control unit 1020. The output unit 1030 may output the audio signals via a plurality of speakers.

In one exemplary embodiment, an audio signal may be processed based on location information of a plurality of speakers present at arbitrary locations, thereby providing a listener with an audio signal having high sound quality.

Methods according to exemplary embodiments may be written as program commands executable via any computer means and recorded in a computer-readable recording medium. The computer-readable recording medium may include a program command, a data file, and a data structure solely or in combination. The program commands recorded in the computer-readable recording medium may be specifically designed and configured for the inventive concept or may be well known to and usable by one of ordinary skill in the art of computer software. Examples of the computer-readable recording medium include magnetic media (e.g., hard disks, floppy disks, and magnetic tapes), optical media (e.g., CD-ROMs and DVDs), magneto-optical media (e.g., floptical disks), and hardware devices specifically configured to store and execute program commands (e.g., ROMs, RAMs, and flash memories). Examples of program commands include not only machine language codes prepared by a compiler, but also high-level language codes executable by a computer by using an interpreter.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

1. A method of processing an audio signal, the method comprising:
obtaining a filter function for enhancing a sound quality of an audio signal;
obtaining location information of a plurality of speakers via which the audio signal is to be output;
correcting the filter function based on the location information; and
processing the audio signal by using the corrected filter function.

2. The method of claim 1, further comprising outputting the processed audio signal such that a sound image of the audio signal is located at a predetermined location on a multimedia device.

3. The method of claim 1, further comprising:
sensing a change in the location information of at least one of the plurality of speakers;
correcting the filter function based on the sensed changed location information; and
processing the audio signal by using the corrected filter function.

4. The method of claim 1, wherein the location information comprises at least one of a distance and angle between each of the plurality of speakers and a listener.

5. The method of claim 1, wherein the correcting of the filter function comprises:
determining parameters based on the location information; and
correcting the filter function by using the parameters.

6. The method of claim 5, wherein the parameters comprise at least one of:
a panning gain for correcting directions of a sound image of the audio signal, based on the location information of the plurality of speakers;
a gain for correcting a sound level of the sound image of the audio signal, based on the location information of the plurality of speakers; and
a delay time for compensating for a phase difference between sound images of the audio signal, based on the location information of the plurality of speakers.

7. The method of claim 1, wherein the filter function comprise a filter function having flat frequency response characteristics in a predetermined frequency band and configured to add a feeling of elevation to the audio signal, or a filter function configured to add notch characteristics to the audio signal, wherein the notch characteristics are characteristics of an audio signal to which the feeling of elevation is added.

8. An apparatus for processing an audio signal, the apparatus comprising:
a receiving unit for obtaining an audio signal and location information of a plurality of speakers via which the audio signal is to be output;
a control unit for obtaining filter function for enhancing a sound quality of the audio signal, correcting the filter function based on the location information, and processing the audio signal by using the corrected filter function; and
an output unit for outputting the processed audio signal via the plurality of speakers.

9. The apparatus of claim 8, wherein the output unit outputs the processed audio signal such that a sound image of the audio signal is located at a predetermined location on a multimedia device.

10. The apparatus of claim 8, wherein the control unit senses a change in the location information of at least one of the plurality of speakers, corrects the filter function based on the sensed changed location information, and processes the audio signal by using the corrected filter function.

11. The apparatus of claim 8, wherein the location information comprises at least one of a distance and angle between each of the plurality of speakers and a listener.

12. The apparatus of claim 8, wherein the control unit determines parameters based on the location information, and corrects the filter function by using the parameters.

13. The apparatus of claim 12, wherein the parameters comprise at least one of:
a panning gain for correcting a direction of a sound image of the audio signal, based on the location information of the plurality of speakers;
a gain for correcting a sound level of the sound image of the audio signal, based on the location information of the plurality of speakers; and
a delay time for compensating for a phase difference between sound images of the audio signal, based on the location information of the plurality of speakers.

14. The apparatus of claim 8, wherein the filter function comprise a filter function having flat frequency response characteristics in a predetermined frequency band and configured to add a feeling of elevation to the audio signal, or a filter function configured to add notch characteristics to the audio signal, wherein the notch characteristics are characteristics of an audio signal to which the feeling of elevation is added.

15. A non-transitory computer-readable recording medium having recorded thereon a program for performing the method of claim 1.
